(19) United States
(12) Patent Application Publication
(10) Pub. No.: US 2005/0244213 A1
(43) Pub. Date: Nov. 3, 2005

(54) Ergonomic binder clip and method for binding sheets of paper

(76) Inventors: Maria Del Carmen, Houston, TX (US); Bonnie K. Smith, Houston, TX (US)

Correspondence Address: William D. Durkee, 11802 Village Park Circle, Houston, TX, 77024, US

(21) Appl. No.: 11/176,531

(22) Filed: Jul. 7, 2005

Related U.S. Application Data
(63) Continuation-in-part of application No. 10/259,682, filed on Sep. 27, 2002.
(60) Provisional application No. 60/325,645, filed on Sep. 28, 2001.

(51) Int. Cl. B42F 3/02

(52) U.S. Cl. 402/19

(57) ABSTRACT

A binder clip and method for holding sheets of paper or other items comprises a clamp including a flexible hinge and gripping surfaces on the inside of the clamp which hold the paper sheets when the clamp is closed, and a spring which slides over the front and back surfaces of the clamp from the location of the hinge to force the clamp closed and push the gripping surfaces toward each other for binding the items together

### CLAIM TO PRIORITY

This application is a continuation-in-part of application Ser. No. 10/259,682 which was filed Sep. 27, 2002, and claims priority based on provisional application Ser. No. 60/325,645 which was filed in the United States on Sep. 28, 2001.

### BACKGROUND OF THE INVENTION

The present invention relates generally to a method for binding paper and other sheets and to a clip, binder, or clamp used for binding or holding papers and other materials together in an organized manner. Existing commercial binder clips for sheets of paper require too much strength and energy for actuation, particularly by persons with disabilities, arthritis, etc. Existing binder clips for paper are made of metal which has sharp metal edges. The existing metal binder clips scratch surfaces made of wood or glass, and tend to rust.

### THE INVENTION

The primary objective of the present invention is to provide a binder clip for paper and other sheets which is durable, economical, and ergonomically designed to be significantly easier and less painful to use in everyday requirements, particularly in the normal office environment. Another objective is to provide a method for binding paper and other sheets in a manner which minimizes the requirement for strength in closing and opening the binder clips. The efficiency and ease in opening and closing also provides a better design for storage and shipping of the binder clips. The preferred material of construction—hard durable plastic and an elastic metal or plastic spring clip—can be colored to be more appealing to the eye and to provide color coding for importance, filing order, or other identification. Because of the ease of opening and closing, the binder clip of the invention does not require enough pressure to cause unexpected spring release and possible injury. When made of plastic, the binder clip of the invention does not tend to scratch or rust.

The invention provides a single binder which can be finger-actuated for holding one or more entities such as sheets of paper and can be finger releasable to release such entities. The binder comprises a clamp having opposing jaws attached along a rotatable joint with the back side of the clamp having a slideway which is substantially perpendicular to the axis of rotation of the joint, and the front side having a slideway on its outer surface.

A closing spring is connected to the clamp along one or more surfaces which mate with the rear slideway to form a slideable connection substantially perpendicular to the axis of rotation of the joint between an open position where the clamp is open and a closed position when the spring is slid over the front slideway to force the clamp into a closed, binding position. The opposing jaws have opposing gripping surfaces which preferably are substantially smooth and which grip the one or more sheets by substantially non-marking friction. The spring is releasable by finger actuation to slide the spring back along the slideway to free the clamp from its closed binding position.

The opposing gripping surfaces are preferably free of teeth, and at least one of the opposing gripping surfaces is substantially flat, or has an arcuate shape. The clamp including the joint preferably comprises a hard plastic material and the spring preferably comprises a hard plastic having elasticity to form a spring. The gripping surfaces may be layers of a plastic gripping material which is different from the hard plastic material of the clamp. The rear slideway may be a channel having opposing side grooves to allow the spring to slide along the channel with ears which slide in the opposing side grooves. The slideway has one or more stops near the rotatable joint to keep the spring from becoming disconnected from the clamp. The opposing side grooves may include stops near the joint to keep the ears and the spring from escaping the slideway. The ears may have various shapes to mate with the grooves.

The spring may have flexing space between the ears to allow the ears to be flexed towards each other and moved past the stops to enter the grooves. The ears should be shaped to allow entry into the grooves, but to restrict removal from the grooves. The clamp can have a detent on the front side which can engage a catch on the spring to hold the spring against the clamp in the closed position. The front of the clamp should have a shape such as a ramp to force the clamp into a binding position.

The spring and clamp may also have mating surfaces along the slideway which comprise a projection on one piece extending through a slot or track on the other to form an interlinked connection between the two pieces along the slideway.

The clamp is shaped for finger-actuation and the front side of the clamp may have a recessed surface below the spring to enhance access to the spring for thumb-actuation to release the spring from the ramp and free the clamp from its closed binding position.

The binder of the invention is preferably a single structural interlocked entity composed of the clamp and the spring, without attachment to other clamps or clamping mechanisms. The binder of the invention includes preferably a clamp which comprises a single structural molding of plastic material, including the joint.

The present invention will be more fully understood from the following detailed description taken in conjunction with the accompanying drawings.

### BRIEF DESCRIPTION OF THE DRAWINGS

FIG. 1 is a back perspective view of the binder clip in an open position in accordance with the invention.

FIG. 2 is a front perspective view of the binder clip of FIG. 1 in an open position.

FIG. 3 is a top perspective view of the binder clip of FIG. 1 in a closed position.

FIG. 4 is a rear perspective view of the binder clip of FIG. 1 in a closed position.

FIG. 5 is a perspective view of the interior of the binder clip of FIG. 1 in an open position with gripping layers 16 and 18 removed.

FIG. 6 is a rear perspective view of an alternative embodiment in a closed position.

FIG. 7 is a side perspective view of the binder clip of FIG. 6 in an open position.

FIG. 8 is a rear angled perspective view of an alternative embodiment in a disconnected position.

FIG. 9 is a front angled perspective view of the alternative embodiment of FIG. 8.

FIG. 10 is a front perspective view of the alternative embodiment of FIGS. 8 and 9 in the closed position.

FIG. 11 is a rear perspective view of the embodiment of FIGS. 8, 9, and 10 in the closed position.

FIG. 12 is a sectional view along the line 12-12 of FIG. 11.

FIG. 13 is a perspective view of the spring illustrated in FIGS. 8, 9, 10, 11 and 12.

FIG. 14 is a partial exploded view of another embodiment in accordance with the invention.

FIG. 15 is a sectional view of an alternative spring illustrating another slideable connection between the clamp and the spring shown in FIG. 14.

FIG. 16 is a sectional view of an alternative spring illustrating another slideable connection between the clamp and the spring shown in FIG. 14.

### DESCRIPTION OF ILLUSTRATIVE EMBODIMENTS

The illustrative embodiments described herein provide a binder clip, holder, or clamp which is lightweight, economical, eye pleasing and ergonomically designed to tightly bind papers and other items while being easy to use and eye appealing for special purposes. While illustrated by means of specific illustrative embodiments of a binder clip, the illustrative embodiments will also find use in a wide-range of applications calling for binding together or holding of items such as photographs, notes, lists, name tags, etc. Therefore, the illustration by means of a binder clip for papers is meant to be illustrative and not limiting, although the binder is particularly suited for binding or clipping sheets of paper.

The binder clip can have a magnetic portion or other attachment mechanism such as hook and loop for holding items like papers, pictures, pot holders, and hand towels on a refrigerator, stove, blackboard, cork board, peg board, and the like. It may also be useful as clips for closing bags and containers. For hanging pictures, calendars, name tags, etc., a ribbon can be entered through the interior of the binder clip or under the spring clip before it is pushed down on the gripping support to create the binder.

In general, a binder clip in accordance with the invention comprises a gripping clamp preferably made of a pair of gripping supports or jaws connected by a joint or hinge to allow the gripping supports or jaws to move towards and away from each other. The interior surfaces of the gripping supports or jaws may have ridges, bumps, a tacky surface, etc., to help hold paper or other material between them, but the gripping surfaces should not have teeth or other surfaces which mark or mar the surface of the materials to be bound. The gripping surfaces are preferably smooth and flat or arcuate to provide a non-marking surface. Small grooves may be molded into the jaws for helping to hold a gripping layer on the jaws.

A closing spring is slideable over the gripping clamp to hold and force the gripping jaws of the clamp together, and to hold the paper or other material between the gripping surfaces of the jaws. The clamp has outside surfaces for receiving a releasable spring to force the gripping surfaces toward each other for binding. The closing spring may be released from holding the gripping surfaces together by finger (including thumb) pressure on a pressure release surface to release and slide the spring to release the force against the gripping clamp.

The gripping clamp preferably has a flat slide surface on the outside of one jaw to guide one leg of the spring clip and an arcuate slide surface or ramp on the outside of the other to cause a leg of the spring clip to engage and force the gripping jaws together to bind the paper or other material between the jaws into a fixed position.

At least one of the slide surfaces has a guide to keep the spring in position as it is set and/or released from the gripping clamp. The guide may comprise a recess, depression, or cavity with side surfaces or grooves, such as parallel side surfaces or grooves which keep the spring clip sliding in a proper relation with the gripping clamp.

The arcuate slide surface preferably has a catch or edge across the arcuate slide surface which forms a lock, detent, or catch with a catch, lock, hook or edge on the spring.

An enlarged finger pressure flange or section on the end of the arcuate leg of the spring clip can be employed to release the lock by exertion of thumb (finger) pressure and slide the spring clip away and release the interior gripping surfaces of the gripping supports.

One side of the gripping clamp preferably has a holding mechanism or restraint which keeps the gripping clamp and the spring clip together when they are not in a forced holding relationship. A slat or bar over and across a recess for one leg along with a projection on a leg of the spring clip can be employed to keep the two parts together. Extended ears on a leg of the spring clip which fit into grooves on the parallel sides of the recess are preferably employed. Projections or guides which slide in slots, tracks, or channels may also be employed. Other mechanisms may also be used, or the binder clip may be made in two separate parts which are mated at the time of use, such as by molding cooperating cylinders on the jaws which can be fitted together to accept a pin to form a hinge.

The binder clip preferably has a finger holding or gripping area on the gripping clamp to allow holding the binder while pushing against and releasing the spring clip from the gripping clamp. This finger holding area is preferably outside of the area for the sliding surfaces between the spring clip and the gripping clamp.

The paper binder clip of the present invention is preferably a single or individual entity or body which comprises two components—a hinged clamp which is not biased together on its own and a spring clip which slides over the hinged clamp after the clamp is in proper clamping position to close the clamp and force it to bind or hold the paper and similar materials in position between the clamp.

In addition, the spring clip does not have to have flat legs. The legs could be cylindrical in shape or partially so, as in the shape of a bobby pin, to force the gripping members or jaws together. In such event, the cylindrical legs or leg could slide through a cylinder or a semicircular conduit in the gripping clamp for alignment and restraint from separation. The other leg of the spring clip could be flat or similar in shape. The clip can be made of metal or metal covered with a plastic. Plastic on the outside is preferred to minimize scratching of surfaces on which the binder is placed, such as desk tops and table tops.

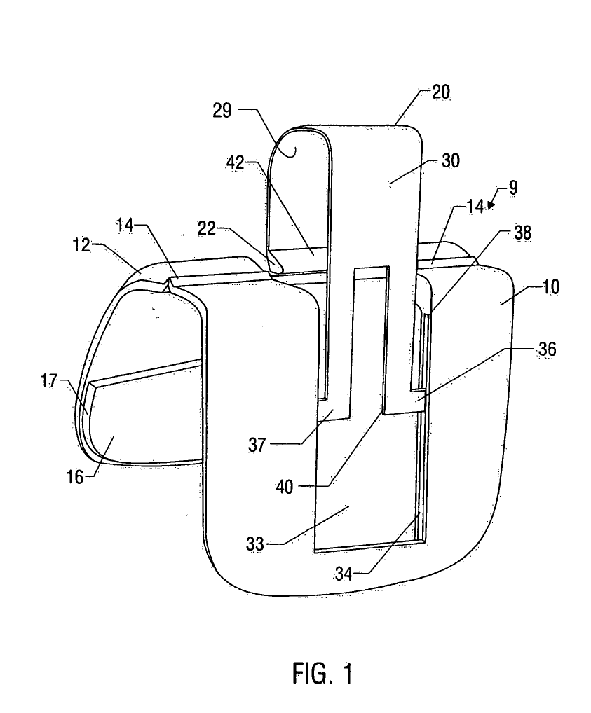

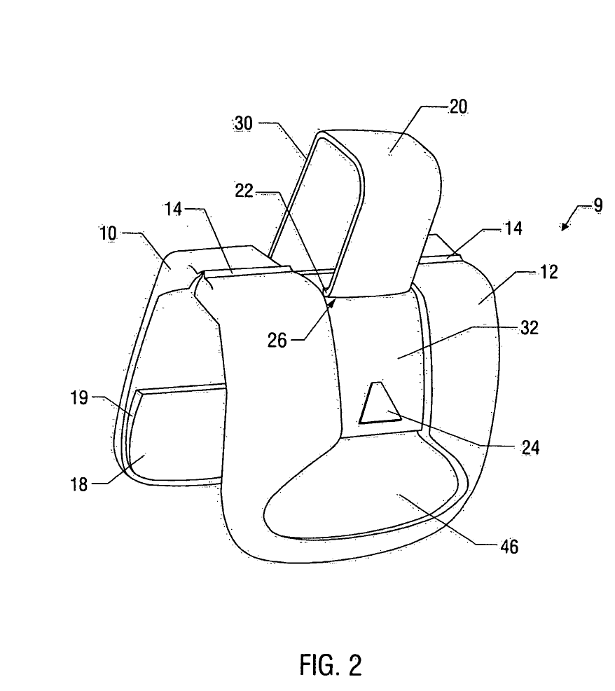

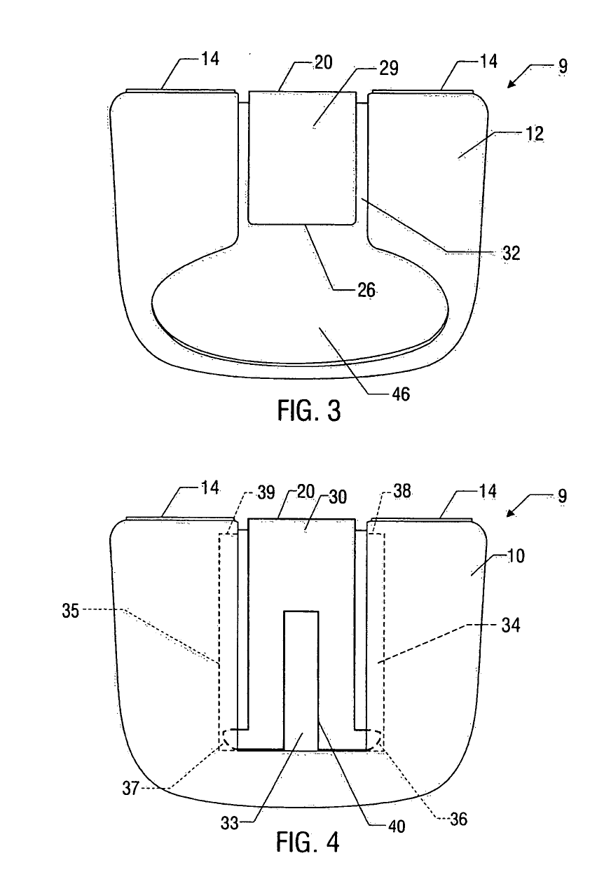

With reference to FIGS. 1 to 5 of the drawings, a lightweight, durable binder clip 9 comprises two gripping jaws or supports 10 and 12 connected by a flexible joint or hinge 14. For integral, molded shapes, the joint is referred to as a “living hinge.” Each inner side of the supports 10 and 12 contain clamping, gripping or binding surfaces 16 and 18 which grip when closed. Clamping surfaces 16 and 18 are the outside surfaces of layers 17 and 19 which may be affixed to the jaws 10 and 12. Each outer side of the supports or jaws 10 and 12 provides a guide area for guiding an actuating spring 20, preferably made of durable spring-like plastic, being pushed down to lock the supports 10 and 12 together in a gripping relationship. The spring clip 20 when pulled or pushed up away from the opposing gripping jaws or supports 10 and 12 causes the binder clip 9 to release and relax the gripping supports 10 and 12 to open the binder clip 9.

The actuating spring 20 is preferably made of a material with a resilient, elastic spring action such as spring plastic or metal so that when it is forced down to bind the jaws or supports 10 and 12 it overlaps and catches a shoulder, catch, or detent 24 provided on the front outer surface of the support 12 to hold the binder in place and clamp it tightly to the papers or other items or materials. The tension in the actuating spring 20 self-adjusts the tightness on the supports 10 and 12 for the thickness of the paper or other item to be bound and requires only light pushing from the top of spring 20 to close the binder clip 9. The shoulder or catch 22 on the spring 20 is shaped so that a push on it from the bottom or spring release end 26, such as by a finger or thumb, slides the shoulder or catch 22 over the corresponding shoulder or detent 24 and causes the binder clip 9 to relax and to open, thereby causing no pain or stress in the fingers or the hand, while opening the binder clip 9. The binder clip 9 is ergonomically better for persons suffering with weakness in the hands and wrist and with hand ailments such as arthritis, digititis, carpal tunnel, or having missing digits, even missing limbs.

With reference to FIGS. 1 to 5, the spring 20 preferably has a front leg 29 and a rear leg 30 on the back side of jaw or support 10 which slides in a retaining slot or channel 33 formed in the support 10, preferably by molding. Retaining slot 33 has opposing grooves 34 and 35 which accept and guide ears 36 and 37 along their length. Opposing grooves 34 and 35 have stops 38 and 39 at their ends near the joint 14. Stops 38 and 39 keep the ears 36 and 37 from disconnecting from the grooves 34 and 35. The ears 36 and 37 are shaped along with flexing compression space 40 to allow the leg 30 to compress inwardly and slide by the stops 38 and 39 during manufacture. After manufacture the ears are not easily removed from the grooves 34 and 35.

The shoulder 22 is preferably shaped to have a surface 42 which mates with an inclined ramp 32 on the jaw or support 12. The shoulder 22 can engage the detent 24 to keep the spring 20 biased against the jaws 10 and 12 and keep the binder clip in a closed position. Front leg 29 has preferably a length in relation to rear leg 30 so that the front leg 29 is free of the jaw 12 in the open position as illustrated in FIGS. 1, 2, and 7.

A thumb or finger depression 46 on the outside of support or jaw 12 may be used to provide space to aid pushing the spring release end 26 of the spring clip 20 with its catch 22 over the detent 24 and the inclined ramp 32 on the gripping jaw 12.

The gripping jaws or supports 10 and 12 are preferably held together in a flexible, moveable relationship by a joint or hinge 14 to form a U-shaped gripping binder, clamp, or saddle which can bind one or more items between its opposing gripping surfaces. This U-shaped gripping binder or saddle is preferably made of a plastic which is sufficiently strong to make substantially rigid opposing gripping surfaces but which can be formed thinner to make the flexible hinge. Preferably, the opposing supports and the flexible joint or hinge are molded from a suitable plastic in one integral piece according to known techniques or to techniques which may be developed. Known plastics may be used or others which become known and which satisfy the desired nature of the structure may be used. Preferred plastics include thermoplastics which can be injection molded, but which can be sufficiently rigid and/or elastic to function as the parts of the binder clip of the invention. Plastics for consideration include abs, abs/nylon, abs/tpu, nylon 6, nylon 6/6, polycarbonate, pc/abs, pps, polypropylene, polysulfone, polyurethane, polyester, liquid cristal polymer, pvc, san, tpe, tpu, tpr, ultem, filled and unfilled grades, composites and many other engineering resins. By selecting the appropriate plastic or composite, and the appropriate molding process, a wide range of surface finish, elasticity, color, and dimensional specifications can be achieved.

A binder clip for paper should include a small size and acceptable width. A rough, tacky or ridged surface for gripping paper may be employed as long as it does not mark or damage the paper. A clamp and an outer spring clip which are covered with plastic or made from plastic to minimize scratching of surfaces should be employed. An improved thumb release surface of the binder clip may be employed to release the spring clip from the clamp. Friction-aiding ridges may be employed.

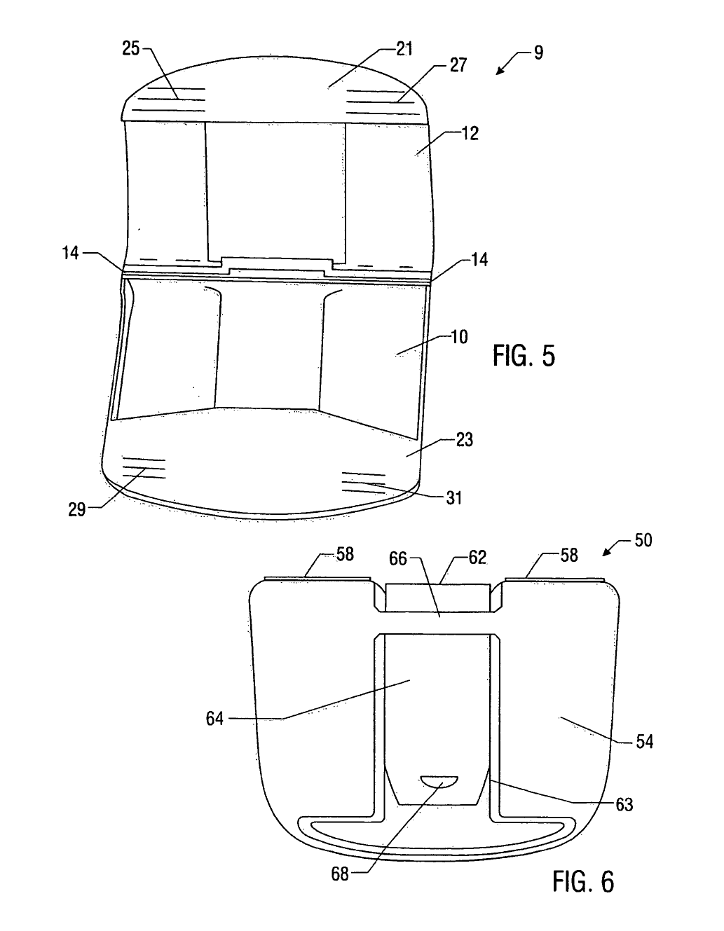

With specific reference to FIG. 5, which is a view of the binder 9 in a fully open position with gripping surfaces 16 and 18 and layers 17 and 19 removed, the interior surfaces 21 and 23 of the jaws 10 and 12 may contain small grooves 25, 27, 29, and 31 which can accept part of the layers 17 and 19 and which may help hold the layers 17 and 19 onto the interior surfaces 21 and 23 of the jaws 10 and 12.

FIGS. 6 and 7 illustrate an alternative embodiment. A binder clip 50 comprises a flexible, U-shaped gripping jaw or support which comprises a back gripping member 54 connected to a front gripping member 56 by a flexible hinge 58. The gripping jaws or supports are preferably made of injection molded plastic. The interior gripping surfaces 59 and 60 are preferably designed to grip paper by one or more flat or arcuate surfaces which do not mark paper. The gripping surfaces should be a design to avoid damage to the paper to be bound.

The spring 62 is held to the binder clip 50 by a back spring leg 64 which slides along a slideway or channel 63 in the back of gripping member 54. Back gripping member 54 has a slat or bar 66 across the channel 63 which holds the spring leg 64 in place by a projection or ridge 68 on the leg 64. Projection or ridge 68 is designed to flex slat or bar 66 outwardly on entry during manufacture but to catch slat 66 across channel 63 and avoid disconnection of the spring 62 from the gripping member 54 when the clip 50 is open.

Alternatively, the binder clip of the invention can be made without a mechanism for keeping the parts together. The spring clip and gripping jaws or support could be made as separate parts and then assembled at the time of use by the user.

The spring clip can also have a central projection or guide which snaps into a central longitudinal groove on the back of the clamp and is retained by such a mechanism. Thus, the spring clip could slide up and down along the back of the clamp to open or shut the clamp. Other parts and functions can be similar to those previously described.

Typical specifications for a binder clip follow. The clip can be 1.75″wide×1.375″long×0.50″thick (no paper)×1.00″thick (100 sheets of paper). The opening of the clip for 100 sheets may be 0.4″. The thickness of clip body may be 0.08″ thick. The material can be C-1500 series semi-rigid urethane plastic with impact resistance, black in color, and hardness of D 70. It can be a Smooth-On product distributed by Reynolds Advanced Materials.

The flexible hinge allows flat jaws with grip rubber surfaces to expand and flatten out on various paper quantities installed between them. Grip rubber material, PMC-121/30, is perhpas the strongest soft urethane rubber available with a hardness of A 30. This urethane rubber is also produced by Smooth-On. The hinge thickness may be 0.005″ and 0.125″ wide between upper and lower clip jaws. The hinge material is preferably the same as for the clip.

The clip may be annotated with O for open and C for closed when operating the clip for paper insertion. The clip spring may be shaped for maximum spring load at 100 sheets of paper. Cycle times are undetermined for maximum use, but similar designs have been cycled over 10,000 times. Material description for the clip is rigid, black in color, with a hardness of D 83-85. It can be polyurethane produced by Camattini, a division of Nest Technologies. The spring can be 0.08″ thick measuring 1.36″ long and 0.375″ wide at slide and 0.5″ wide at push annotation side to prevent rocking of the spring back and forth in a slide channel.

Prototypes for the clip have been made of a vulcanized urethane plastic with an approximate durometer hardness of D70 resembling stiff plastics like ABS. Colors can be pigmented or mixed prior to mold injection. Prototypes for the spring have been made of a vulcanized urethane plastic with D95 hardness with a flexural spring or give of 18%.

The clip is auto adjustable with a flexible hinge to accept various quantities of paper without distorting or marring paper surface when in contact with the gripping surfaces. In use, paper is held in one hand and the clip in the other. Paper is inserted between clip gripping surfaces while pushing the clip spring forward in direction of close. Prior to closure of the spring, the clamp is held with the flexible hinge away from the palm, thumb on the front jaw, with fingers stabilizing the clamp on bottom of the rear jaw for insertion of paper or other items. By pushing back on the spring the clamp will open to accept paper or other items. By moving the spring to a closed position, such as by a fore finger, the clamp will bind the sheets of paper or other items.

In accordance with the above description, the invention provides a method for clamping and binding at least one sheet of paper or plastic or other sheet material, such as photographs. The method comprises placing over a portion of a peripheral margin of at least one sheet an open clamp which has opposing jaws attached along a rotatable joint with the jaws having an open position and a size to fit over the portion of the peripheral margin. The jaws also have a closed binding position displaced from the rotatable joint to bind at least one sheet of material.

The method includes forcing the clamp to the closed position which binds at least one sheet by moving a closing spring over the front and back sides of the clamp away from the rotatable joint to cause a binding action. The closing spring is forced to slide along a slideway in the clamp between a stop in the clamp near the rotatable joint to keep the clamp and spring connected when in the open position and the closed binding position displaced from the rotatable joint.

The binding action may be released from at least one sheet of paper or other material by moving the spring back to the stop near the rotatable joint and freeing the clamp from the margin. This may be done by finger actuation.

The method preferably includes moving the spring from the open position to the closed position along a slideway in which the clamp and spring are slideably engaged by mating surfaces which are interlinked between the stop and a location near the closed position to retain the spring on the clamp and bind at least one sheet of material within the clamp. The method also preferably includes interlinking the mating surfaces near the closed position and keeping the spring connected to the clamp at that position by the force of the spring on the clamp. Thus, the interlinking connection is formed when the spring is near the closed connection, because the force of the spring on the clamp keeps the two pieces together at the engagement location.

Thus, the mating surfaces along the slideway interlink as the closing spring is moved from a location near the closed position toward the stop and remain interlinked when reaching the stop to keep the spring connected to the clamp in the open position.

The method of the invention is particularly advantageous when multiple sheets need to be bound together and the peripheral margin of the stack comprises front and back marginal areas of multiple stacked sheets.

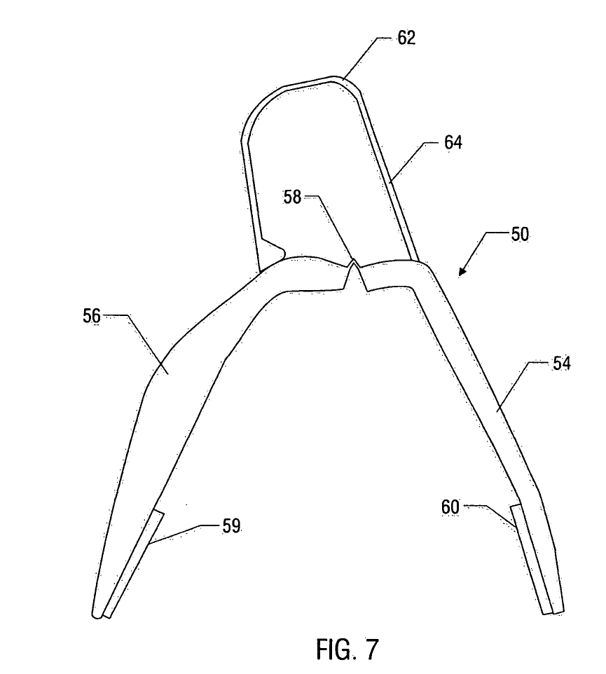

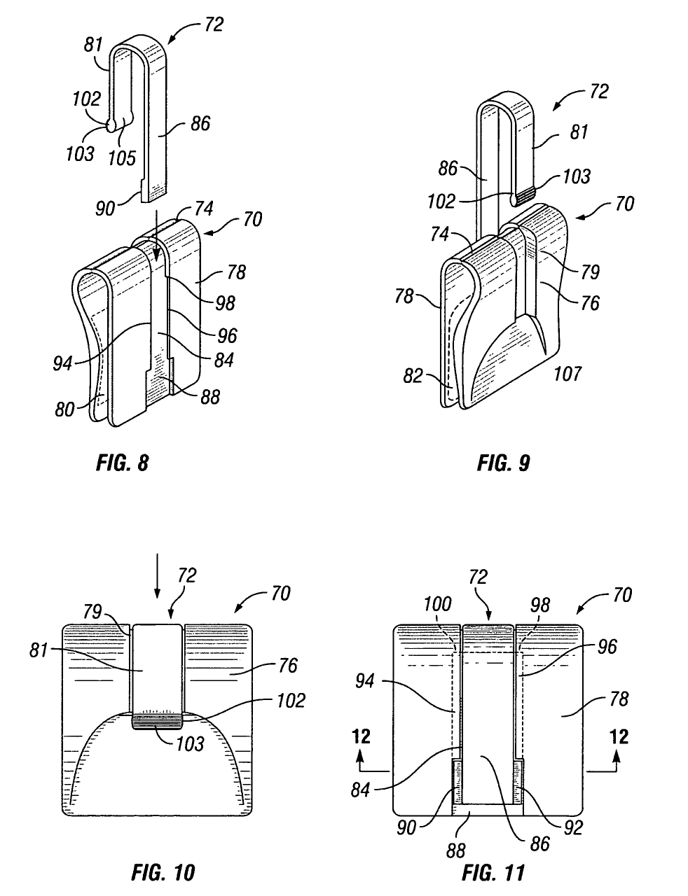

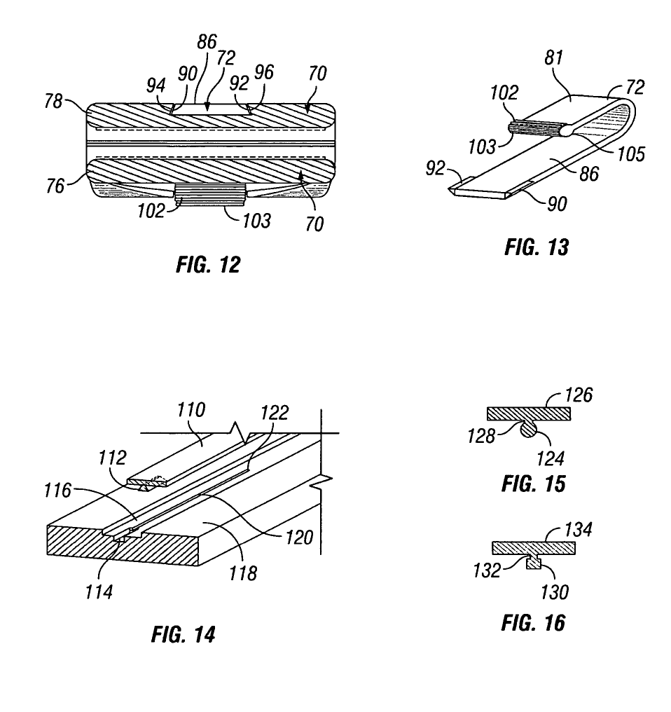

With reference to FIGS. 8, 9, 10, 11, 12 and 13, an additional embodiment of the invention is illustrated. The binder clip illustrated comprises a clamp 70 and a closing spring 72. The clamp 70 has a “living” molded hinge 74 connecting a front jaw or support76 and a rear jaw or support 78.

The front jaw 76 may have an arcuate binding surface 80 which fits against a flat binding surface 82 on the rear jaw 78. These opposing-shapes help enable the binding surfaces 80 and 82 to adjust to the thicknesses of the varying thickness of the material or sheets to be bound. The binding surfaces 80 and 82 may contain a coating or insert of a material which improves friction against the material to be bound without marring its surfaces. A tacky material may be employed.

The spring 72 slides over the front and back surfaces of jaws 76 and 78. Front jaw 76 may contain a slideway 79 for the front portion or leg 81 of the spring 72. The rear jaw 78 preferably contains a slideway 84. When the spring 72 is installed over the clamp 70 to the closed position, as illustrated in FIGS. 10 and 11, the front portion or leg 81 of the spring 72 slides through the slideway 79 to the closed position where the spring 72 fits snug over the clamp 70 and forces the clamp 70 into a closed binding position with binding or gripping surfaces 80 and 82 being faced toward each other.

The rear portion or leg 86 of the spring 72 slides along the slideway 84 until it reaches the closed position where it fits into an entry location 88 on or near the bottom end. At this entry location 88, the spring 72 is held firmly on the clamp 70 by the binding force of the spring on the clamp.

When the spring 72 is moved toward the open position the ears 90 and 92 on or neareither side of the bottom of the rear leg 86 enter mating triangular grooves 94 and 96 on opposite sides of the slideway 84. Grooves 94 and 96 end at stops 98 and 100 which keep the spring 72 connected to the clamp 70. The ears 90 and 92 preferably have sufficient length and strength along the grooves 94 and 96 to keep the rear portion or leg 86 of the spring 72 flat against the slideway 84 in the open position.

Many other variations can be designed for the interlinking connection between the spring and the clamp to keep them connected for ease of use without undesirable movement in relation to each other. The two pieces are preferably kept tight against each other even though in a slideable engagement.

The front leg 81 of the spring 72 may contain an upraised portion, protrusion, or finger-pressure release surface 102 to aid in finger actuation to release and move the spring back to the open position. The upraised portion or protrusion 102 may contain ridges 103 to help avoid slippage. Grooves or a rough surface may also be employed. The under side may include a catch 105 which engages detent 107 in the closed position. The shape of catch 105 should be designed to keep the binder closed when engaging detent 107 but to allow a relatively easy release of the catch 105 over the detent 107 to open the binder clip.

Other illustrative alternatives for the interlinked connection are illustrated in FIGS. 14, 15, and 16. With reference to FIG. 14, the rear leg 110 of the closing spring contains a trapezoidal projection or guide 112 which fits into an entry location 114 in the slideway 116 on the back of the rear jaw 118 of the clamp.

The projection 112 mates with a reverse trapezoidal retaining slot, track, or channel 120 which extends along the slideway 116 to a stop 122 to limit further movement from the closed to open position. The projection 112 preferably has sufficient length and strength to keep the spring and clamp together without breaking or disconnecting in the open position.

Alternatively, the projection 112 and the entry location 114 could be located farther from the bottom end of the slideway 116 to allow the extra length of the rear leg 110 to cooperate with the projection to keep the spring against the clamp.

FIG. 15 is a sectional view of a projection or guide 124 on a rear leg 126 of a spring which has the form of a cylinder of appropriate length with a thin connection 128 which slides in a retaining track, slot, or channel in a slideway.

FIG. 16 illustrates a square or rectangular shape or guide 130 with a thin connection 132 attached to a rear leg 134 for the same purposes.

In addition, the interlinking connections can be reversed between the spring and the clamp particularly to aid in manufacture or ease of use, and the stops can also be reversed or otherwise changed.

Modifications may be made by persons skilled in the art to the above described illustrative embodiments without departing from the principles, concepts, and equivalents which are involved in the binder of the invention.

1. A method for clamping and binding at least one sheet of paper or plastic, which method comprises:
a) placing over a portion of a peripheral margin of at least one sheet an open clamp which has opposing jaws attached along a rotatable joint, the jaws having an open position and a size to fit over the portion of the peripheral margin and a closed binding position displaced from the rotatable joint to bind at least one sheet, and
b) forcing the clamp to the closed position which binds at least one sheet by moving a closing spring over the front and back sides of the clamp away from the rotatable joint to cause a binding action, the closing spring sliding along a slideway in the clamp between a stop in the clamp near the rotatable joint to keep the clamp and spring connected when in the open position and the closed binding position displaced from the rotatable joint.

2. The method of claim 1 in which the binding action is released from at least one sheet by moving the spring back to the stop near the rotatable joint and freeing the clamp from the margin.

3. The method of claim 1 in which the spring is moved from the open position to the closed position along a slideway in which the clamp and spring are slideably engaged by mating surfaces which are interlinked between the stop and near the closed position to retain the spring on the clamp and bind at least one sheet within the clamp.

4. The method of claim 3 in which the mating surfaces become interlinked near the closed position and the spring is kept connected to the clamp at that position by the force of the spring on the clamp.

5. The method of claim 1 in which mating surfaces along the slideway interlink as the closing spring is moved from near the closed position toward the stop and remain interlinked when reaching the stop to keep the spring connected to the clamp in the open position.

6. The method of claim 1 in which at least one sheet constitutes multiple sheets and the peripheral margin comprises front and back marginal areas of multiple stacked sheets.

7. A single binder which is finger-actuated for holding one or more sheets and is finger-releasable to release such sheets, which single binder comprises:
(1) a clamp having opposing jaws attached along a rotatable joint, the back side of the clamp having a slideway which is substantially perpendicular to the axis of rotation of the joint and the front side having a detent on its outer surface;
(2) a closing spring connected to the clamp along one or more surfaces which mate with the slideway to form a slideable interlinked connection substantially perpendicular to the axis of rotation of the joint between an open position where the clamp is open and a closed position when the spring is slid over the detent to force the clamp into a closed, binding position;
(3) the opposing jaws having opposing gripping surfaces which grip the one or more sheets by substantially non-marking friction; and
(4) the spring being releasable by finger actuation to slide the spring back from the detent to free the clamp from its closed binding position while retaining the spring connected to the clamp in the open position.

8. The binder of claim 7 in which the interlinked connection keeps the closing spring flat against the slideway from the closed position to the open position.

9. The binder of claim 7 in which the opposing gripping surfaces are free of teeth and are substantially smooth.

10. The binder of claim 7 in which at least one of the opposing gripping surfaces is substantially flat.

11. The binder of claim 7 in which at least one of the opposing gripping surfaces has an arcuate shape.

12. The binder of claim 7 in which the slideway has one or more stops near the rotatable joint to keep the spring from becoming disconnected from the clamp.

13. The binder of claim 7 in which the slideway is a channel having opposing side grooves, the closing spring slides along the channel and has ears which slide in the opposing side grooves, and the opposing side grooves have stops near the joint to keep the ears and the spring from escaping the slideway.

14. The binder of claim 13 in which the spring has space between the ears to allow the ears to be flexed and moved past the stops to enter the grooves.

15. The binder of claim 7 in which the detent comprises a ramp on the clamp and a catch on the spring which engages over an end of the ramp to hold the spring against the clamp in the closed position.

16. The binder of claim 7 in which the clamp is shaped for finger-actuation and the front side of the clamp beyond the detent has a recessed surface to enhance access to the spring for thumb-actuation to release the spring from the detent and free the clamp from its closed binding position.

17. The binder of claim 7 in which the interlinked connection comprises a slot and a projection which projects through and slides along the slot and which has an enlarged portion on one side of the slot to slide along the slot toward the open position to prevent the enlarged portion from escaping through the slot in the open position.

18. A binder which is finger-actuated for holding one or more sheets and is finger-releasable to release such sheets, which binder is a single entity composed of:
(1) a clamp having opposing jaws attached along a rotatable joint, the back side of the clamp having a slideway which is substantially perpendicular to the axis of rotation of the joint and the front side having a ramp on its outer surface;
(2) a closing spring connected to the clamp along one or more surfaces which mate with the slideway to form a slideable connection substantially perpendicular to the axis of rotation of the joint between an open position where the clamp is open and a closed position when the spring is slid over the ramp to force the clamp into a closed, binding position;
(3) the slideway has one or more stops near the rotatable joint to keep the spring from becoming disconnected from the clamp and the slideable connection having mating surfaces which keep the closing spring flat against the slideway from the closed position to the open position;
(4) the opposing jaws having opposing gripping surfaces which grip the one or more sheets by substantially non-marking friction;
(5) the spring being releasable by finger actuation to slide the spring back over the ramp to free the clamp from its closed binding position; and
(6) the clamp including the joint comprises a hard plastic molding and the spring comprises a plastic molding having elasticity to form a spring.

19. The binder of claim 18 in which the slideway is a channel having opposing side grooves and the spring slides along the channel and has ears which slide in the opposing side grooves.

20. The binder of claim 18 in which the slideable connection comprises a slot and a projection which projects through and slides along the slot and which has an enlarged portion on one side of the slot to slide along the slot toward the open position to prevent the enlarged portion from escaping through the slot in the open position.
